(19) United States
(12) Patent Application Publication
(10) Pub. No.: US 2004/0012284 A1
(43) Pub. Date: Jan. 22, 2004

(54) Segmented machine casing and method of making the same

(76) Inventors: Darin L. Denton, Idaho Springs, CO (US); Erik Christopher Hatch, Denver, CO (US); Jeff Frazzini, Westminster, CO (US)

Correspondence Address: William C. Rowland, BURNS, DOANE, SWECKER & MATHIS, L.L.P., P.O. Box 1404, Alexandria, VA, 22313-1404, US

(21) Appl. No.: 10/197,414

(22) Filed: Jul. 18, 2002

(51) Int. Cl. H02K 9/00; H02K 5/00

(52) U.S. Cl. 310/89

(57) ABSTRACT

A method of assembling a substantially cylindrical motor casing having a plurality of cooling elements, includes the steps of forming a plurality of sections, each of the sections including a plurality of cooling channels extending therethrough in a longitudinal direction or a plurality of cooling fins extending therefrom, and each of the sections including an edge on each side thereof, each of the edges extending substantially parallel to the plurality of cooling channels or cooling fins; and connecting the plurality of sections together along their respective edges so as to form a substantially cylindrical shape from the plurality of sections.

### BACKGROUND OF THE INVENTION

1. Field of the Invention

The present invention relates to a casing for an electric motor, and a method of making the same.

2. Description of Related Art

In the discussion of the related art that follows, reference is made to certain structures and/or methods. However, the following references should not be construed as an admission that these structures and/or methods constitute prior art. Applicant expressly reserves the right to demonstrate that such structures and/or methods do not qualify as prior art against the present invention, if appropriate.

A conventional electric motor includes a stator having a rotor extending through a center thereof. The stator and rotor assembly is encased in a substantially cylindrical casing or cooling jacket. The casing or cooling jacket typically is part of a frame or housing that locates and supports one or more bearings which receive the shaft and support the rotor within the stator.

Conventional casings for electric motors are typically formed from cast or forged metal. The metals used in the casings include steel or corrosion resistant alloys, such as aluminum alloys. The damping properties, weight, cooling ability, and other characteristics of the casing are a function of the materials used to construct the casing, as well as the geometry of the motor construction.

Conventionally, such casings were formed using two coaxial cylindrical jackets, mutually connected in order to produce one or more passageways through which either air or liquid coolant flows. Such an arrangement is commonly referred to as a “cooling jacket” and is illustrated in FIGS. 1 and 3 of U.S. Pat. No. 5,019,737. See also FIG. 4 of U.S. Pat. No. 6,300,693.

Air or a cooling fluid can be urged through the cooling jacket by appropriate means mounted on one end of the chamber, and is then exhausted from the other end of the chamber.

Such cooling jackets frequently include fins that aid in heat transfer. See, for example, elements 37 in FIG. 4 of U.S. Pat. No. 6,300,693 and elements 12 in FIG. 2 of U.S. Pat. No. 5,448,118.

When such casings are formed from a cast or forged metal, wall portions of the casing may contain small inclusions or defects on the interior surface thereof. Filling the inclusions or defects is a time consuming and expensive process. In addition, casting has inherent difficulties with regard to casting deep and constant cross-sectional holes having an accurate configuration. Accordingly, when such casings are cast, further machining operations may be required in order to achieve a sufficiently high dimensional accuracy.

In order to overcome some of the problems with cast products, some motor casings are formed by an extrusion process. In such a process, a billet of aluminum alloy or some other metal is pushed through a design of some predetermined size and shape. The extrusion process has better dimensional accuracy than common casting methods. Accordingly, an extruded casing is able to include a more complex shape, particularly in the axial direction, than can be easily accomplished with a cast product.

However, due to limitations in the extrusion process, it is difficult to create a large diameter hollow extruded part.

### OBJECTS AND SUMMARY

It is an object of the present invention to provide a machine casing that can be easily made with high tolerances.

It is an additional object of the present invention to provide a machine casing that can be made from extruded parts, wherein the completed casing assembly has a large internal diameter.

It is yet another object of the present invention to provide a machine casing that can be manufactured in a relatively simple process.

According to one aspect of the present invention, a method of assembling a substantially cylindrical motor casing having a plurality of cooling channels extending therethrough includes forming a plurality of sections, each of the sections including a plurality of cooling channels extending therethrough in a longitudinal direction, and each of the sections including an edge on each side thereof, each of the edges extending substantially parallel to the plurality of cooling channels, and connecting the plurality of sections together along their respective edges so as to form a substantially cylindrical shape from the plurality of sections.

According to one aspect of the present invention, a method of assembling a substantially cylindrical motor casing having a plurality of cooling elements includes forming a plurality of sections, each of the sections including a plurality of cooling channels extending therethrough in a longitudinal direction or a plurality of cooling fins extending therefrom, and each of the sections including an edge on each side thereof, each of the edges extending substantially parallel to the plurality of cooling channels or cooling fins, and connecting the plurality of sections together along their respective edges so as to form a substantially cylindrical shape from the plurality of sections.

It is another aspect of the present invention to provide a substantially cylindrical motor casing, wherein the motor casing includes a plurality of sections, each of the sections including a plurality of cooling channels extending therethrough in a longitudinal direction, and each of the sections including an edge on each side thereof, wherein each of the edges extends substantially parallel to the plurality of cooling channels. The motor casing further includes a joining seam between each of the plurality of sections, whereby each of the plurality of sections is secured to an adjacent one of plurality of sections by the joining seam, and wherein there are more cooling channels than seams.

In yet another aspect of the present invention, an electrical motor comprises a casing composed of a plurality of sections, wherein each of the sections includes a plurality of cooling channels extending therethrough in a longitudinal direction, and each of the sections includes an edge on each side thereof. Each of the edges extends substantially parallel to the plurality of cooling channels, and a joining seam is arranged between each of the plurality of sections, whereby each of the plurality of sections is secured to an adjacent one of the plurality of sections by the joining seam, and wherein there are more cooling channels than seams. The electric motor further comprises an end cap at each end of the casing, a stator secured to an interior of the casing, and a rotor and a rotor shaft, wherein the rotor shaft is centered by the end caps.

In yet another aspect of the present invention, an electrical motor comprises a casing composed of a plurality of sections, each of the sections including a plurality of cooling channels extending therethrough in a longitudinal direction or a plurality of cooling fins extending therefrom, each of the sections including an edge on each side thereof, each of the edges extending substantially parallel to the plurality of cooling channels or cooling fins, and a joining seam between each of the plurality of sections, whereby each of the plurality of sections is secured to an adjacent one of the plurality of sections by the joining seam; an end cap at each end of the casing; a stator secured to an interior of the casing; and a rotor and rotor shaft, the rotor shaft being secured at the end caps.

### BRIEF DESCRIPTION OF THE DRAWINGS

FIG. 1 is a schematic view of an embodiment of the present invention.

FIG. 2 is a view of a conventional motor casing.

FIG. 3 is a view of a segment of a motor casing according to one embodiment of the present invention.

FIG. 4 is a detailed view of a cooling channel according to one embodiment of the present invention.

FIG. 5 is a view of a plurality of segments joined together to form a cylindrical casing according to one embodiment of the present invention.

FIG. 6 is a side view of a portion of a motor casing according to one embodiment of the present invention.

FIG. 7 illustrates the end faces of the segments in an alternative embodiment.

FIG. 8 is a view of a segment of a motor casing according to another embodiment of the present invention.

### DETAILED DESCRIPTION OF THE PREFERRED EMBODIMENTS

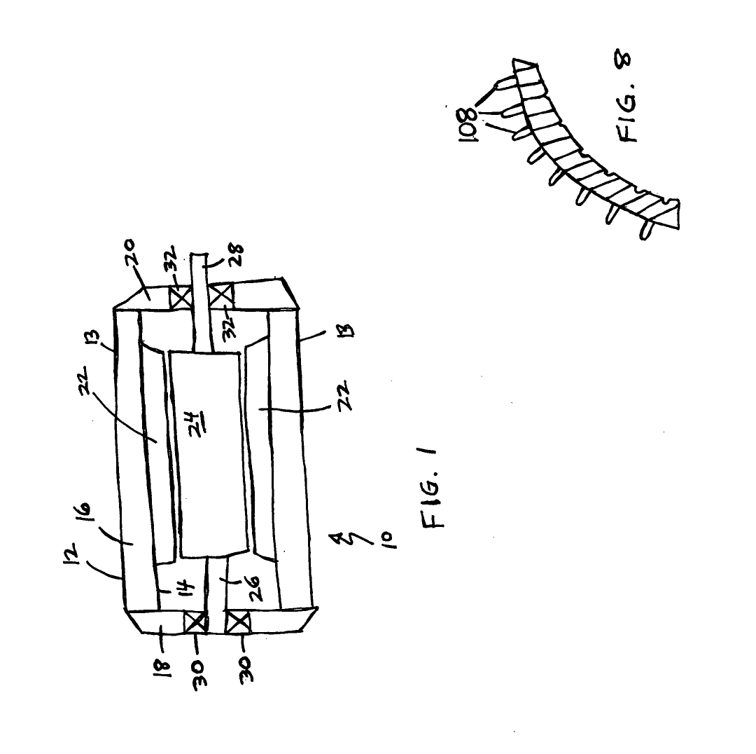

FIG. 1 is a schematic view of one embodiment of a motor made according to the present invention.

The motor 10 includes a cylindrical casing 13 having an external wall 12 and an internal wall 14. The external wall 12 and the internal wall 14 define a space 16 therebetween through which a cooling fluid may be passed in order to cool the motor 10.

End caps 18, 20 are secured at each end of the cylindrical casing 13 formed by the external wall 12 and the internal wall 16. A stator 22 is secured to an internal surface of the casing 13. And, a rotor 24 is secured within the stator 22 by rotor shafts 26, 28. The rotor shafts are secured to the end caps 18, 20 by bearings 30, 32.

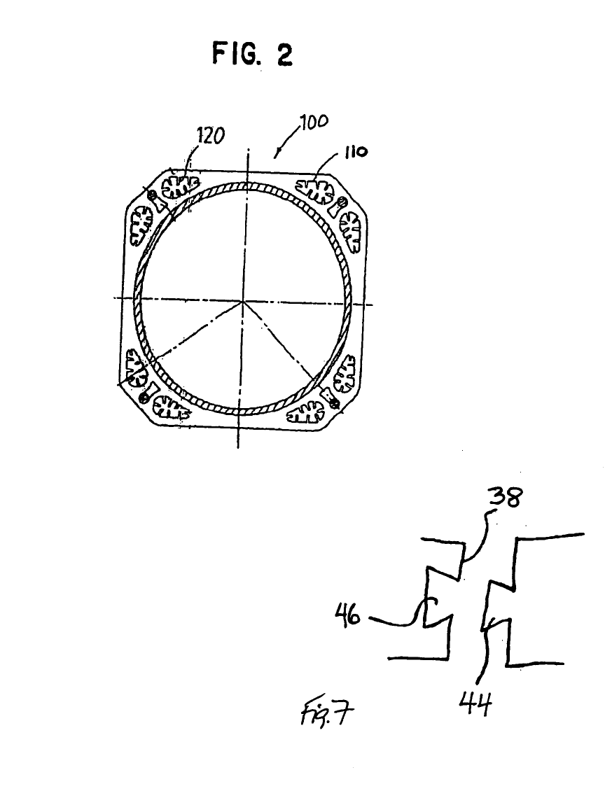

In order to provide adequate structural integrity to the casing 13, the casing is typically formed from a plurality of individual cooling channels. FIG. 2 is a cross-sectional view of a prior art casing 100 showing a plurality of cooling channels 110. Each of the cooling channels 110 has cooling fins 120 extending internally. According to U.S. Pat. No. 5,448,118, the casing 100 is formed by an extrusion process. However, due to inherent constraints in the extrusion process, it is difficult to extrude a casing having a diameter that is significantly larger than four inches in diameter.

In order to overcome the difficulty with extruding a large diameter casing, according to a preferred embodiment of the present invention, the casing 13 is formed from a plurality of casing segments 34, one of which is illustrated in FIG. 3. The casing segment 34 can be easily extruded in a conventional manner. Preferably, the casing segment 34 is extruded using aluminum, magnesium, or an alloy of aluminum or magnesium. However, other materials may be used to form the casing, as will be appreciated by those of ordinary skill in the art. Accordingly, the present invention is not limited to segments formed from one of the disclosed materials. In addition, the segments 34 can be made from processes other than extruding. For example, the segments can be cast or forged. Accordingly, the present invention is not limited to any particular process for making the segments 34.

Each of the segments 34 includes a plurality of cooling channels 36 extending longitudinally therethrough. In a preferred embodiment, the cooling channels 36 are substantially elongated in shape. However, the present invention is not limited to the particular shape of the cooling channels illustrated in the figures. The cooling channels may be formed in any suitable shape.

FIG. 4 illustrates a detailed enlargement of a cooling channel 36. According to one preferred embodiment of the present invention, each of the cooling channels 36 includes a plurality of cooling fins 40 extending internally into the cooling channel. The cooling fins 40 enhance the ability to transfer heat from the cooling fluid to the casing 13.

In a preferred embodiment of the present invention, each segment 34 forms an arc of about 90 degrees. However, arcs of different extents may be utilized in accordance with the teachings of the present invention. Specifically, the arc may be 15 degrees, 30 degrees, 45 degrees, 60 degrees, 90 degrees, 120 degrees, or 180 degrees.

Preferably, each of the segments 34 in a casing 13 is of the same arcuate extent. However, there is no reason why different sized segments could be used in the same casing. For example, a combination of segments could be used, as long as the total arcuate extent of the segments comprised a complete 360 degrees.

As illustrated in FIG. 5, the segments 34 are joined together at their end faces 38 in order to form a complete cylinder. In a preferred embodiment of the present invention, the segments 43 are welded together at weld seams 42. However, other means for joining the segments 34 together may be contemplated by those of ordinary skill in the art. Accordingly, the present invention is not limited to joining the segments 34 together by welding. For example, it is possible that the segments 34 could be mechanically fastened together, or could be joined together using some type of suitable adhesive.

In addition, although FIG. 3 illustrates that the end faces 38 of each of the segments 34 is substantially flat, the end faces 38 could be made with a unique configuration, such as a dove-tail configuration 46 as illustrated in FIG. 7. Alternatively, the end faces 38 could have an arrangement of peaks and valleys so that the end faces could join together in an interlocking manner in order to improve the seal created between the end faces.

In addition to welding or otherwise sealing the segments 34 together, if necessary, one or more bands or straps can be secured around the casing 13 in order to enhance the structural integrity of the casing 13.

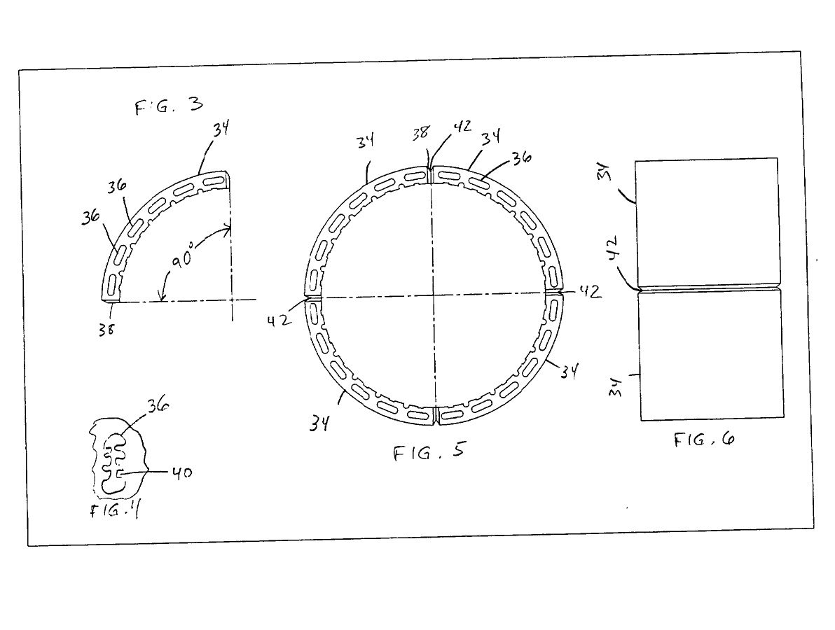

FIG. 6 illustrates a side view of two segments 34 joined together with a welded seal 42.

In yet another embodiment of the present invention, the casing has cooling fins or plates extending inwardly or outwardly, instead of, or in addition to, the cooling passages. For example, FIG. 8 is a view of a segment having cooling fins 108 extending therefrom. The cooling fins 108 may be in the form of thin plates, or of any other shape that may serve to assist in cooling of the casing.

In a preferred embodiment, the present invention is used to form a housing for a brushless electric motor. However, the casing of the present invention may have other applications as well.

Although only preferred embodiments are specifically illustrated and described herein, it will be appreciated that many modifications and variations of the present invention are possible in light of the above teachings and within the purview of the appended claims without departing from the spirit and intended scope of the invention.

What is claimed is:

1. A method of assembling a substantially cylindrical motor casing having a plurality of cooling channels extending therethrough, the method comprising:
forming a plurality of sections, each of the sections including a plurality of cooling channels extending therethrough in a longitudinal direction, and each of the sections including an edge on each side thereof, each of the edges extending substantially parallel to the plurality of cooling channels; and
connecting the plurality of sections together along their respective edges so as to form a substantially cylindrical shape from the plurality of sections.

2. The method of claim 1, wherein the forming step includes extruding the plurality of sections.

3. The method of claim 1, wherein the forming step includes extruding the plurality of sections such that each of the sections is in an arcuate shape.

4. The method of claim 1, wherein the forming step includes forming the plurality of sections such that each of the sections is in an arcuate shape.

5. The method of claim 1, wherein the connecting step includes welding the plurality of sections together.

6. The method of claim 1, wherein the forming step includes forming the plurality of sections such that each of the sections includes about 90 degrees of a cylinder.

7. The method of claim 1, wherein the forming step includes forming the plurality of sections such that each of the sections includes at least three cooling channels.

8. The method of claim 1, wherein the forming step includes forming the plurality of sections such that each of the sections includes at least five cooling channels.

9. The method of claim 1, wherein the forming step includes forming the plurality of sections such that each of the sections includes at least six cooling channels.

10. The method of claim 1, further comprising the step of attaching an end cap at each end of the substantially cylindrical motor casing.

11. The method of claim 1, wherein the forming step includes forming the plurality of sections such that each of the sections includes at least one cooling fin in each of the cooling channels.

12. The method of claim 2, wherein the connecting step includes welding the plurality of sections together.

13. The method of claim 1, wherein the forming step includes forming the plurality of sections such that each of the sections is monolithic.

14. A method of assembling a substantially cylindrical motor casing having a plurality of cooling elements, the method comprising:
forming a plurality of sections, each of the sections including a plurality of cooling channels extending therethrough in a longitudinal direction or a plurality of cooling fins extending therefrom, and each of the sections including an edge on each side thereof, each of the edges extending substantially parallel to the plurality of cooling channels; and
connecting the plurality of sections together along their respective edges so as to form a substantially cylindrical shape from the plurality of sections.

15. A method of assembling a substantially cylindrical motor casing having a plurality of cooling fins extending therefrom, the method comprising:
forming a plurality of sections, each of the sections including a plurality of cooling fins extending therefrom, and each of the sections including an edge on each side thereof, each of the edges extending substantially parallel to the plurality of cooling channels; and
connecting the plurality of sections together along their respective edges so as to form a substantially cylindrical shape from the plurality of sections.

16. A substantially cylindrical motor casing, comprising:
a plurality of sections, each of the sections including a plurality of cooling channels extending therethrough in a longitudinal direction, and each of the sections including an edge on each side thereof, each of the edges extending substantially parallel to the plurality of cooling channels;
a joining seam between each of the plurality of sections, whereby each of the plurality of sections is secured to an adjacent one of the plurality of sections by the joining seam;
wherein there are more cooling channels than seams.

17. The substantially cylindrical motor casing of claim 16, wherein each of the plurality of sections includes an arc of about 90 degrees such that the substantially cylindrical motor casing includes four of the sections.

18. The substantially cylindrical motor casing of claim 17, wherein each of the plurality of sections includes at least three cooling channels.

19. The substantially cylindrical motor casing of claim 16, wherein each of the plurality of sections includes at least five cooling channels.

20. The substantially cylindrical motor casing of claim 16, wherein each of the plurality of sections includes at least six cooling channels.

21. The substantially cylindrical motor casing of claim 16, further comprising an end cap at each end of the substantially cylindrical motor casing.

22. The substantially cylindrical motor casing of claim 16, wherein the joining seams are welded seams.

23. The substantially cylindrical motor casing of claim 17, wherein the joining seams are welded seams.

24. The substantially cylindrical motor casing of claim 18, wherein the joining seams are welded seams.

25. The substantially cylindrical motor casing of claim 18, wherein the motor casing has an internal diameter of more than four inches.

26. The substantially cylindrical motor casing of claim 18, wherein the plurality of sections are made from aluminum, magnesium, copper, or an alloy of aluminum, magnesium, or copper.

27. The substantially cylindrical motor casing of claim 18, wherein each of the plurality of sections is monolithic.

28. An electric motor, comprising:
a casing composed of a plurality of sections, each of the sections including a plurality of cooling channels extending therethrough in a longitudinal direction, each of the sections including an edge on each side thereof, each of the edges extending substantially parallel to the plurality of cooling channels, and a joining seam between each of the plurality of sections, whereby each of the plurality of sections is secured to an adjacent one of the plurality of sections by the joining seam;
an end cap at each end of the casing;
a stator secured to an interior of the casing; and
a rotor and rotor shaft, the rotor shaft being secured at the end caps.

29. The electric motor of claim 28, wherein each of the plurality of sections includes an arc of about 90 degrees such that the electric motor includes four of the sections.

30. The electric motor of claim 29, wherein each of the plurality of sections includes at least three cooling channels.

31. The electric motor of claim 28, wherein the joining seams are welded seams.

32. The electric motor of claim 28, wherein the casing has an internal diameter of more than four inches.

33. The electric motor of claim 28, wherein the plurality of sections are made from aluminum, magnesium, copper, or an alloy of aluminum, magnesium, or copper.

34. The electric motor of claim 28, wherein the electric motor is a brushless permanent magnet motor.

35. The electric motor of claim 28, wherein each of the plurality of sections is monolithic.

36. The electric motor of claim 28, wherein there are more cooling channels than seams.

37. An electric motor, comprising:
a casing composed of a plurality of sections, each of the sections including a plurality of cooling channels extending therethrough in a longitudinal direction or a plurality of cooling fins extending therefrom, each of the sections including an edge on each side thereof, each of the edges extending substantially parallel to the plurality of cooling channels or cooling fins, and a joining seam between each of the plurality of sections, whereby each of the plurality of sections is secured to an adjacent one of the plurality of sections by the joining seam;
an end cap at each end of the casing;
a stator secured to an interior of the casing; and
a rotor and rotor shaft, the rotor shaft being secured at the end caps.
